(19) United States
(12) Patent Application Publication
(10) Pub. No.: US 2025/0247698 A1
(43) Pub. Date: Jul. 31, 2025

(54) SENSING AUTHENTICATION METHOD AND APPARATUS, AND NODE

(71) Applicant: VIVO MOBILE COMMUNICATION CO., LTD., Dongguan (CN)

(72) Inventor: Yannan YUAN, Dongguan (CN)

(21) Appl. No.: 19/182,817

(22) Filed: Apr. 18, 2025

Related U.S. Application Data
(63) Continuation of application No. PCT/CN2023/124482, filed on Oct. 13, 2023.

(30) Foreign Application Priority Data
Oct. 20, 2022 (CN) 202211289252.1

(51) Int. Cl. H04W 12/06; H04W 24/10; H04W 48/02; H04W 64/00

(52) U.S. Cl. CPC H04W 12/06; H04W 24/10; H04W 48/02; H04W 64/00

(57) ABSTRACT

A sensing authentication method includes obtaining, by a first node, a sensing request and sensing authorization information corresponding to the sensing request, and performing, by the first node, sensing authentication based on the sensing authorization information. An authentication result of the sensing authentication is used to indicate whether to perform sensing requested by the sensing request. The sensing authorization information includes at least one of sensing area authorization information, sensing target authorization information, or sensing device authorization information.

### CROSS-REFERENCE TO RELATED APPLICATIONS

This application is a bypass continuation application of International Application No. PCT/CN2023/124482, filed on Oct. 13, 2023, which claims the benefit of and priority to Chinese Patent Application No. 202211289252.1, filed on Oct. 20, 2022, where the foregoing applications are incorporated herein by reference in their entireties.

### TECHNICAL FIELD

This application relates to the field of integrated communication and sensing technologies and, more specifically, relates to a sensing authentication method and apparatus, and a node.

### BACKGROUND

Integrated communication and sensing refers to the implementation of both functions within the same system through the sharing of spectrum and hardware. While transmitting information, the system can also sense data such as an orientation, a distance, and a speed, as well as detect, track, and identify a target device or event. The communication and sensing systems work together to enhance overall performance and improve the service experience.

### BRIEF SUMMARY

Embodiments of this application provide a sensing authentication method and apparatus, and a node.

According to a first aspect, a sensing authentication method is provided, including:
obtaining, by a first node, a sensing request and sensing authorization information corresponding to the sensing request; and
performing, by the first node, sensing authentication based on the sensing authorization information, where an authentication result of the sensing authentication is used to indicate whether to perform sensing requested by the sensing request; where
the sensing authorization information includes at least one of sensing area authorization information, sensing target authorization information, and sensing device authorization information.

According to a second aspect, a sensing authentication apparatus is provided, including:
a first obtaining module, configured to obtain a sensing request and sensing authorization information corresponding to the sensing request; and
a sensing authentication module, configured to perform sensing authentication based on the sensing authorization information, where an authentication result of the sensing authentication is used to indicate whether to perform sensing requested by the sensing request; where
the sensing authorization information includes at least one of sensing area authorization information, sensing target authorization information, and sensing device authorization information.

According to a third aspect, a first node is provided. The first node includes a processor and a memory, the memory stores a program or instructions that are capable of being run on the processor, and when the program or the instructions are executed by the processor, the steps of the method according to the first aspect are implemented.

According to a fourth aspect, a first node is provided, including a processor and a communication interface. The communication interface is configured to obtain a sensing request and sensing authorization information corresponding to the sensing request. The processor is configured to perform sensing authentication based on the sensing authorization information, where an authentication result of the sensing authentication is used to indicate whether to perform sensing requested by the sensing request, and the sensing authorization information includes at least one of sensing area authorization information, sensing target authorization information, and sensing device authorization information.

According to a fifth aspect, a readable storage medium is provided. The readable storage medium stores a program or instructions, and when the program or the instructions are executed by a processor, the steps of the method according to the first aspect are implemented.

According to a sixth aspect, a chip is provided. The chip includes a processor and a communication interface, the communication interface is coupled to the processor, and the processor is configured to run a program or instructions to implement the method according to the first aspect.

According to a seventh aspect, a computer program/program product is provided. The computer program/program product is stored in a storage medium, and the computer program/program product is executed by at least one processor to implement the steps of the method according to the first aspect.

In embodiments of this application, a first node obtains a sensing request and at least one of sensing area authorization information, sensing target authorization information, and sensing device authorization information corresponding to the sensing request, to perform sensing authentication, so as to determine, based on an authentication result, whether to perform sensing requested by the sensing request. Therefore, authorization and authentication of a sensing area, a sensing target, or a sensing device involved in the sensing are addressed. The embodiments can ensure security and privacy of sensing, prevent unauthorized sensing of a specific area or a specific target, and prevent unauthorized designation of a sensing device from causing the sensing device to be tracked or captured.

### BRIEF DESCRIPTION OF DRAWINGS

FIG. 1 is a block diagram of a wireless communication system to which the embodiments of this application can be applied;

FIG. 2 is a flowchart of steps of a sensing authentication method according to an embodiment of this application;

FIG. 3 is a schematic diagram of a structure of a sensing authentication apparatus according to an embodiment of this application;

FIG. 4 is a schematic diagram of a structure of a communication device according to an embodiment of this application; and

FIG. 5 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6th generation (6th Generation, 6G) communication system.

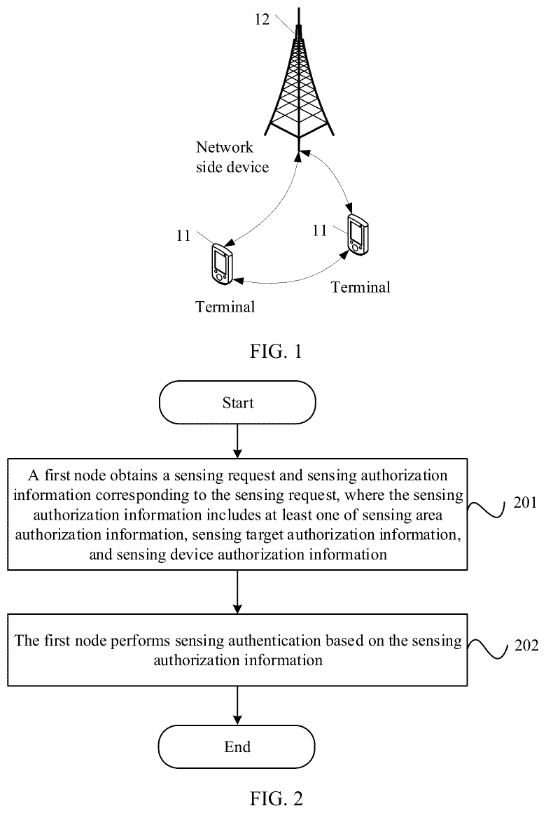

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer that is also referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device (Wearable Device), vehicle-mounted user equipment (VUE), pedestrian user equipment (PUE), a smart home device (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another proper term in the art. The base station is not limited to a specific technical vocabulary provided that a same technical effect is achieved. It should be noted that in the embodiments of this application, a base station in an NR system is merely used as an example for description, but does not limit a specific type of the base station.

For ease of understanding, some content involved in the embodiments of this application is described below.

### I. Integrated Communication and Sensing

Integrated communication and sensing means that in a same system, a design of integrated communication and sensing functions is implemented through spectrum sharing and hardware sharing. When transferring information, the system can sense information such as an orientation, a distance, and a speed, and detect, track, and identify a target device or an event. A communication system and a sensing system cooperate with each other, to improve overall performance and bring better service experience.

A future mobile communication system, such as a beyond 5-generation (Beyond 5G, B5G) mobile communication system or a 6G mobile communication system, has a sensing capability in addition to a communication capability. The sensing capability is that one or more devices with the sensing capability can sense information such as an orientation, a distance, and a speed of a target object by sending and receiving a wireless signal, or detect, track, identify, and image a target object, an event, an environment, or the like. In the future, with the deployment of a small base station with a capability of a high frequency band and high bandwidth such as millimeter wave and terahertz in a 6G network, resolution of sensing is significantly improved when compared with that of a centimeter wave, so that the 6G network can provide a more precise sensing service. Typical sensing functions and application scenarios are shown in Table 1.

Expressions of quality of service requirements for the foregoing sensing services are different. For example, a quality of service requirement for sensing such as intelligent traffic or a high-accuracy map is usually expressed by using a sensing distance, range resolution, angle resolution, velocity resolution, and a sensing latency; a quality of service requirement for flight intrusion detection sensing is usually expressed by using coverage height, sensing accuracy, and a sensing latency; a quality of service requirement for respiration monitoring is expressed by using a sensing distance, a sensing real-time characteristic, sensing resolution, and sensing accuracy; a quality of service requirement for indoor intrusion detection is expressed by using a sensing distance, a sensing real-time characteristic, a detection probability, and a false alarm probability; and a quality of service requirement for gesture/posture recognition is expressed by using a sensing distance, a sensing real-time characteristic, and sensing accuracy.

Service requesting manners for the foregoing sensing services are different. For example, for a service request based on a static area, a specific coordinate system is used to represent a geographic location area of content that needs to be sensed; for a service request based on a dynamic area, M meters around specific user equipment (UE) are used to represent a geographic location range of content that needs to be sensed, where M is a positive number; and for a continuous sensing service request for a specific dynamic target, a specific target of detected and continuous location tracking is used to represent a sensing target whose content needs to be sensed.

TABLE 1

| Communication | | |
|---|---|---|
| sensing | | |
| category | Sensing function | Application scenario |
| Macro sensing | Weather conditions, air quality, and the | Meteorology, agriculture, and |
| type | like | life services |
| | Traffic flow (intersections) and crowd | Intelligent traffic and |
| | flow (subway entrances) | commercial services |
| | Target tracking, distance measurement, | Many application scenarios of a |
| | speed measurement, outlining, and the | conventional radar |
| | like | |
| | Environment reconstruction | Intelligent driving and |
| | | navigation |
| | | (automobiles/unmanned aerial |
| | | vehicles), smart city (3D maps), |
| | | network planning, and network |
| | | optimization |
| Granular | Action/posture/expression recognition | Smart interaction of |
| sensing type | | smartphones, games, and smart |
| | | home |
| | Heartbeat/breathing and the like | Health and medical care |
| | Imaging, material detection, | Security inspection, industry, |
| | component analysis, and the like | biological medicine, and the |
| | | like |

### II. Registration and Authentication of UE in a Communication Process

In a registration process of UE and a network, if authentication needs to be performed, an access and mobility management function (AMF) requests an authentication server function (AUSF) to perform authentication. The AUSF performs UE authentication based on request information of the AMF. The AUSF selects a unified data management (UDM) entity, and obtains authentication data from the UDM. Selection of the UDM is mainly based on at least one of the following:
1. A home network identifier (for example, a mobile network code (MNC) or a mobile country code (MCC)) of a subscription concealed identifier (SUCI)/a subscription permanent identifier (SUPI), a network identifier (NID) (provided by a next-generation radio access network (NG-RAN)) of a stand-alone non-public network (SNPN), and a route indicator of the UE.
2. A UDM group ID of a SUPI of a terminal.
3. A SUPI or an internal group ID, where a UDM NF consumer selects a UDM instance based on a SUPI range to which a SUPI of the UE belongs or a result of a discovery process that uses a SUPI of the UE or an internal group ID as a network repository function (Network Repository Function, NRF) of a UDM discovery input.
4. A GPSI or an external group ID, where when a UDM NF consumer does not know a SUPI/SUCI (for example, an NEF), the UDM NF consumer selects a UDM instance based on a generic public subscription identifier (GPSI) of the UE or a GPSI or an external group ID range to which an external group ID belongs, or a result of a discovery process that uses a GPSI or an external group ID of the UE as an NRF of a UDM discovery input.

Data obtained by the AUSF from the UDM includes:
a SUCI or a SUPI; and
a service network name.

If a disaster roaming service indication is received from a security anchor functionality (SEAF),
the AUSF sends an authentication result to the UDM, including a SUPI, a timestamp of authentication time/type, and a service network name. Therefore, the UDM stores the foregoing authentication status information (the SUPI, the authentication result, the timestamp, and the service network name) of the UE.

### III. Description of an Authentication Manner

1. Credential (Token) authentication process:

A user enters a login credential.

A server verifies that the credential is correct and then returns a signed token.

A client is responsible for storing the token, which can be stored locally or in a cookie.

A request for the server carries this token.

The server decodes a JWT. If the token is valid, the server processes the request. Once the user logs out, the client destroys the token.
2. An authentication and authorization process in an open authorization (OAuth) protocol mainly includes: obtaining an unauthorized request token; obtaining a request token authorized by a user; and using the authorized request token to obtain an access token. Details are as follows:

The client (third-party software) requests an unauthorized RequestToken from an OAuth service provider. In other words, a request is initiated to a RequestToken URL.

The OAuth service provider agrees a request of the user and issues an unauthorized oauth_token to the user and a corresponding oauth_token_secret and returns the unauthorized oauth_token and the corresponding oauth_token_secret to the user.

The user requests RequestToken authorized by the user from the OAuth service provider. In other words, a request is initiated to a UserAuthorization URL, and an unauthorized token issued by the service provider in the previous step and a key thereof are added to the request.

The OAuth service provider requires the user to log in and guide the user to complete authorization through a web page.

After the RequestToken is authorized, the user initiates a request to an AccessToken URL and replaces the RequestToken authorized in the previous step with AccessToken. Compared with the first step, one more parameter is requested, that is, RequestToken.

The OAuth service provider agrees to the request of the user, issues Access Token and a key corresponding to AccessToken to the user, and returns the AccessToken and the key corresponding to AccessToken to the user.

The user can use AccessToken returned in the previous step to access a resource authorized by the user.

With reference to the accompanying drawings, a sensing authentication method provided in the embodiments of this application is described in detail below by using specific embodiments and application scenarios thereof.

An existing network performs bidirectional authentication between a terminal and the network for communication. An authentication and key negotiation process is to implement mutual authentication between the terminal and the network, and to provide key materials that can be used between the terminal and a service network in a subsequent security process. Selection of a unified data management (UDM) function and UDM information are mainly authorization and authentication information that uses a terminal identifier as an index.

For sensing, if a receiving or sending device of a sensing signal is UE or the like, for authentication and authorization, bidirectional authentication for sensing needs to be performed on a basis of communication. In addition to the foregoing sensing signal sending or receiving, sensing is also related to a sensing auxiliary node (for example, providing sensing auxiliary information such as geographic location information), a sensing result generation node (converting a sensing measurement result into a sensing result required by a requesting party), and the like. Different sensing devices may support different functions, even some or all functions based on conditions. Therefore, authorization and authentication of a sensing function performed by a sensing device need to be further resolved. In other words, a related technology provides only an authentication method based on a terminal identifier. In the integrated communication and sensing technology, a sensing device may be a network function node in addition to a terminal. Therefore, a related authentication method cannot be applicable to authentication in the integrated communication and sensing field.

At the same time, sensing authorization and authentication may also involve a sensing target and/or a sensing area. If the sensing target has a communication capability (for example, UE or a tag), sensing is usually referred to as device-based sensing. In addition, sensing further includes device-free sensing. For example, sensing targets in flight path management and base station and terminal beam management are respectively an unmanned aerial vehicle and a terminal. When the unmanned aerial vehicle and the terminal each are user equipment that has a signal sending or receiving capability, the unmanned aerial vehicle and the terminal belong to a device-based communication and sensing scenario. Sensing targets in weather monitoring and respiration monitoring are respectively rainfall and human. Both of rainfall and human are targets that do not have a signal sending or receiving capability, and belong to a device-free communication and sensing scenario. Sensing further includes sensing of a specified area. In sensing of a specified area, a specific type of sensing target may be sensed, or there may be no sensing target. For example, in vehicle speed sensing in a highway area, a sensing target type is vehicle speed, and in high-speed railway perimeter intrusion detection, there is no specified type of sensing target, and a typical type of intrusion foreign matter may include an address disaster (such as landslide, landslide, or rockfall), a vehicle (such as a train or a motor vehicle), and a human/animal (such as pedestrian, a cow, or a sheep).

Therefore, sensing authentication needs to resolve authentication of at least one of a sensing area, a sensing target, and a sensing device, and is used as basic assurance of sensing security privacy.

As shown in FIG. 2, an embodiment of this application provides a sensing authentication method, including the following steps.
Step 201: A first node obtains a sensing request and sensing authorization information corresponding to the sensing request.
Step 202: The first node performs sensing authentication based on the sensing authorization information, where an authentication result of the sensing authentication is used to indicate whether to perform sensing requested by the sensing request.

The sensing authorization information includes at least one of sensing area authorization information, sensing target authorization information, and sensing device authorization information.

Optionally, if the authentication result is that the authentication passes, succeeds, or is valid, it is determined that the sensing requested by the sensing request is performed; or otherwise, it is determined not to perform the sensing requested by the sensing request.

Optionally, the first node is a network function node, for example, at least one of a network exposure function (NEF) node, a sensing function (SF) node, an access and mobility management function (AMF) node, and an authentication server function (AUSF) node.

Optionally, the sensing area is an area in which a network performs sensing, such as a highway area or a specific house area. The sensing area authorization information may be provided by an owner of a sensing area and/or a manager of a sensing area.

Optionally, a sensing target is an object on which the network performs sensing, for example, an unmanned aerial vehicle terminal. When the sensing target has a network-identifiable identifier, it is more suitable for the network to authorize and authenticate the sensing target. The sensing target authorization information may be provided by the sensing target and/or an owner of the sensing target and/or a manager of the sensing target.

Optionally, a sensing device is a device that performs at least one function in sensing signal sending, sensing signal receiving, sensing signal measurement, sensing auxiliary data reporting, and sensing result generation. The sensing device may be UE, a base station, a network function, or the like. The sensing device authorization information may be provided by the sensing device and/or an owner of the sensing device.

In this embodiment of this application, the first node obtains the sensing request and at least one of the sensing area authorization information, the sensing target authorization information, and the sensing device authorization information corresponding to the sensing request, to perform sensing authentication, so as to determine whether to perform the sensing requested by the sensing request. Therefore, authorization and authentication of the sensing area, the sensing target, or the sensing device involved in the sensing are addressed. This embodiment can ensure security and privacy of sensing, prevent unauthorized sensing of a specific area or a specific target, and prevent unauthorized designation of a sensing device from causing the sensing device to be tracked or captured.

In at least one embodiment of this application, the sensing area authorization information includes at least one of the following:
first indication information indicating that sensing is allowed in a first area;
a range that is of the first area and that is allowed to be sensed;
second indication information indicating that sensing is prohibited in the first area;
a range that is of the first area and that is prohibited from being sensed; and
communication information of a device that has an authorization permission for the first area.

For example, communication information of the device that has the authorization permission for the first area is a device identifier of the device. When the area sensing authorization information is updated or each time the sensing request queries whether to grant authorization, the device identifier is used by the network to receive area sensing authorization update information or exchange sensing authorization information. For example, the device identifier is a user equipment (UE) identifier (for example, a SUPI or a telephone number) of a manager of the area, and a server access address (for example, an Internet Protocol (IP) address and/or a port number) of the manager of the area.

Optionally, the range that is of the first area and that is allowed to be sensed includes at least one of the following:
content that is of the first area and that is allowed to be sensed, which is also referred to as a sensing result of the first area that is allowed to be sensed, and is a sensing result that is required by a sensing service and that is calculated by the network based on sensing measurement data; potential sensing content, including a distance, a speed, an orientation, a location, a trajectory, whether a target exists, environment reconstruction, respiration monitoring, heartbeat monitoring, motion identification, weather monitoring, air quality detection, and material composition analysis;
sensing measurement data that is of the first area and that is allowed to be sensed, where the sensing measurement data includes at least one of a first-level measurement quantity and a second-level measurement quantity in the following sensing measurement quantities;
a sensing request sending node allowed by the first area, which may also be referred to as a sensing requester, an initiator of the sensing request, a sending device of the sensing request, or the like, for example, the sensing request sending node is indicated by using at least one of an IP address, a port number, or a UE ID (for example, a subscriber permanent identifier SUPI or a telephone number);
a sensing result receiving node allowed by the first area, which may also be referred to as a sensing result user, a sensing result receiving device, or the like, for example, the sensing result receiving node is indicated by using at least one of an IP address, a port number, or a UE ID (for example, a subscriber permanent identifier SUPI or a telephone number);
a sensing device allowed by the first area, where the sensing device is a device that performs at least one of sensing signal sending, sensing signal receiving, sensing signal measurement, sensing auxiliary data reporting, and sensing result generation;
time during which the first area is allowed to be sensed; and
sensing quality of service (QOS) allowed by the first area, where the sensing quality of service QoS includes at least one of sensing performance indicators in Table 2. For example, sensing is allowed in a case that accuracy is lower than a specific value, and the accuracy may be sensing accuracy, sensing resolution, or the like.

Optionally, the range that is of the first area and that is prohibited from being sensed includes at least one of the following:
content that is of the first area and that is prohibited from being sensed, which may also be referred to as a sensing result of the first area that is prohibited from being sensed, and potential sensing content includes a distance, a speed, an orientation, a location, a trajectory, whether a target exists, environment reconstruction, respiration monitoring, heartbeat monitoring, motion identification, weather monitoring, air quality detection, and material composition analysis;
sensing measurement data that is of the first area and that is prohibited from being sensed;
a sensing request sending node prohibited by the first area, which may also be referred to as a sensing requester, an initiator of the sensing request, a sending device of the sensing request, or the like, for example, the sensing request sending node is indicated by using at least one of an IP address, a port number, or a UE ID (for example, a subscriber permanent identifier SUPI or a telephone number);
a sensing result receiving node prohibited by the first area, which may also be referred to as a sensing result user, a sensing result receiving device, or the like, for example, the sensing result receiving node is indicated by using at least one of an IP address, a port number, or a UE ID (for example, a subscriber permanent identifier SUPI or a telephone number);
a sensing device prohibited by the first area, where the sensing device is a device that performs at least one of sensing signal sending, sensing signal receiving, sensing signal measurement, sensing auxiliary data reporting, and sensing result generation;
time during which the first area is prohibited from being sensed; and
sensing quality of service QoS prohibited by the first area, for example, sensing is prohibited in a case that accuracy is higher than a specific value.

In at least one embodiment of this application, the sensing target authorization information includes at least one of the following:
third indication information indicating that a first target is allowed to be sensed;
a range that is of the first target and that is allowed to be sensed;
fourth indication information indicating that the first target is prohibited from being sensed;
a range that is of the first target and that is prohibited from being sensed; and
communication information of a device that has an authorization permission for the first target.

For example, communication information of the device that has the authorization permission for the first target is a device identifier of the device. When the target sensing authorization information is updated or each time the sensing request queries whether to grant authorization, the device identifier is used by the network to receive target sensing authorization update information or exchange sensing authorization information. If the sensing target is UE, the communication information may be an ID such as a SUPI/IMSI of the UE.

Optionally, the range that is of the first target and that is allowed to be sensed includes at least one of the following:
content that is of the first target and that is allowed to be sensed, which is also referred to as a sensing result of the first target that is allowed to be sensed, and is a sensing result that is required by a sensing service and that is calculated by the network based on sensing measurement data; potential sensing content, including a distance, a speed, an orientation, a location, a trajectory, whether a target exists, environment reconstruction, respiration monitoring, heartbeat monitoring, motion identification, weather monitoring, air quality detection, and material composition analysis;
sensing measurement data that is of the first target and that is allowed to be sensed, where the sensing measurement data includes at least one of a first-level measurement quantity and a second-level measurement quantity in the following sensing measurement quantities;
a sensing request sending node allowed by the first target, which may also be referred to as a sensing requester, an initiator of the sensing request, a sending device of the sensing request, or the like, for example, the sensing request sending node is indicated by using at least one of an IP address, a port number, or a UE ID (for example, a subscriber permanent identifier SUPI or a telephone number);
a sensing result receiving node allowed by the first target, which may also be referred to as a sensing result user, a sensing result receiving device, or the like, for example, the sensing result receiving node is indicated by using at least one of an IP address, a port number, or a UE ID (for example, a subscriber permanent identifier SUPI or a telephone number);
a sensing device allowed by the first target, where the sensing device is a device that performs at least one of sensing signal sending, sensing signal receiving, sensing signal measurement, sensing auxiliary data reporting, and sensing result generation;
time during which the first target is allowed to be sensed;
an area in which the first target is allowed to be sensed; and
sensing quality of service QoS allowed by the first target, where the sensing quality of service QoS includes at least one of sensing performance indicators in Table 2. For example, sensing is allowed in a case that accuracy is lower than a specific value, and the accuracy may be sensing accuracy, sensing resolution, or the like.

Optionally, the range that is of the first target and that is prohibited from being sensed includes at least one of the following:
content that is of the first target and that is prohibited from being sensed, which is also referred to as a sensing result of the first target that is prohibited from being sensed, and is a sensing result that is required by a sensing service and that is calculated by the network based on sensing measurement data; potential sensing content, including a distance, a speed, an orientation, a location, a trajectory, whether a target exists, environment reconstruction, respiration monitoring, heartbeat monitoring, motion identification, weather monitoring, air quality detection, and material composition analysis;
sensing measurement data that is of the first target and that is prohibited from being sensed, where the sensing measurement data includes at least one of a first-level measurement quantity and a second-level measurement quantity of the following sensing measurement quantity;
a sensing request sending node prohibited by the first target, which may also be referred to as a sensing requester, an initiator of the sensing request, a sending device of the sensing request, or the like, for example, the sensing request sending node is indicated by using at least one of an IP address, a port number, or a UE ID (for example, a subscriber permanent identifier SUPI or a telephone number);
a sensing result receiving node prohibited by the first target, which may also be referred to as a sensing result user, a sensing result receiving device, or the like, for example, the sensing result receiving node is indicated by using at least one of an IP address, a port number, or a UE ID (for example, a subscriber permanent identifier SUPI or a telephone number);
a sensing device prohibited by the first target, where the sensing device is a device that performs at least one of sensing signal sending, sensing signal receiving, sensing signal measurement, sensing auxiliary data reporting, and sensing result generation;
time during which the first target is prohibited from being sensed;
an area in which the first target is prohibited from being sensed; and
sensing quality of service QoS prohibited by the first target, where the sensing quality of service QoS includes at least one of sensing performance indicators in Table 2. For example, sensing is prohibited in a case that accuracy is higher than a specific value, and the accuracy may be sensing accuracy, sensing resolution, or the like.

In at least one embodiment of this application, the sensing device authorization information includes at least one of the following:
fifth indication information indicating that a first device is allowed to participate in sensing;
a range in which the first device is allowed to participate in sensing;
sixth indication information indicating that the first device is prohibited from participating in sensing; and
a range in which the first device is prohibited from participating in sensing.

Optionally, the range in which the first device is allowed to participate in sensing includes at least one of the following:
a sensing function that the first device is allowed to participate in, where the sensing function includes at least one of sensing signal sending, sensing signal receiving, sensing signal measurement, sensing auxiliary data reporting, and sensing result generation;
seventh indication information indicating that the first device is allowed to be determined by a sensing request sending node to participate in sensing;
eighth indication information indicating a sensing request sending node that is allowed to determine that the first device participates in sensing;
a sensing measurement quantity allowed by the first device, where the sensing measurement quantity includes at least one of the following sensing measurement quantities:
sensing auxiliary data allowed by the first device, where the sensing auxiliary data includes at least one of location information, time information, speed information, and target identification information.

The location information is a global positioning system (GPS) location, a relative location based on a reference object, or the like. The time information is absolute time, relative time, or the like. The speed information is static, low-speed, high-speed, or a specific speed value. The target identification information is a camera image that includes a target identifier such as a license plate, or a permanent identifier such as a SUPI of target UE in a case that the target is UE. This is not specifically limited herein.

Optionally, the range in which the first device is prohibited from participating in sensing includes at least one of the following:
ninth indication information indicating that the first device is prohibited from being determined by a sensing request sending node to participate in sensing;
tenth indication information indicating a sensing request sending node that is prohibited from determining that the first device participates in sensing;
a sensing measurement quantity prohibited by the first device, where the sensing measurement quantity includes at least one of the following sensing measurement quantities:
sensing auxiliary data prohibited by the first device, where the sensing auxiliary data includes at least one of location information, time information, speed information, and target identification information.

The location information is a GPS location, a relative location based on a reference object, or the like. The time information is absolute time, relative time, or the like. The speed information is static, low-speed, high-speed, or a specific speed value. The target identification information is a camera image that includes a target identifier such as a license plate, or a permanent identifier such as a SUPI of target UE in a case that the target is UE. This is not specifically limited herein.

It should be noted that the sensing QoS includes at least one performance indicator and corresponding information (for example, a value requirement) shown in Table 2.

TABLE 2
Definition of sensing performance indicators

| Sensing performance | |
|---|---|
| indicator | Definition |
| Sensing accuracy | The sensing accuracy refers to a degree of deviation between a |
| | real result and a sensing result at a specific confidence level, and |
| | may be represented by a sensing error (for example, a root mean |
| | square error). A smaller sensing error indicates higher sensing |
| | accuracy. The sensing accuracy includes distance accuracy, speed |
| | accuracy, angle accuracy, other sensing accuracy, and the like. |
| Sensing resolution | The sensing resolution is a capability of distinguishing between a |
| | plurality of sensing targets from different dimensions, including |
| | range resolution, velocity resolution, angle resolution, and the like. |
| Sensing distance | The sensing distance is a valid range of a specific sensing |
| | parameter while a specific sensing performance indicator (for |
| | example, sensing accuracy) is met and specifically includes a |
| | sensing distance range, a sensing speed range, a sensing angle |
| | range, and the like. |
| Sensing latency | The sensing latency is used to quantitatively describe a real-time |
| | requirement of a sensing service, such as a maximum delay from |
| | generating a sensing service request to feeding back a sensing |
| | result. |
| Sensing update | The sensing update frequency is a reciprocal of a time interval |
| frequency | between two adjacent sensing results. |

It should be noted that, in a potential classification manner, sensing measurement quantities are classified into the following four types (this description focuses on describing a measurement quantity, or the sensing measurement quantities may be classified into three types or not classified, and the four types are merely an example). A third-level measurement quantity and a fourth-level measurement quantity below are also usually referred to as sensing results based on a relationship between a sensing measurement quantity and a sensing service. A second-level measurement quantity and/or a first-level measurement quantity are/is referred to as sensing measurement data.
a) The first-level measurement quantity (a received signal/original channel information) includes a received signal/channel response complex result, an amplitude/phase, an I-channel/Q-channel and operation results thereof (operations include addition, subtraction, multiplication, and division, matrix addition, subtraction, and multiplication, matrix transposition, a trigonometric operation, a square root operation, and a power operation, as well as threshold detection results and maximum/minimum value extraction results, and the like of results of the foregoing operations; and the operations further include fast Fourier transform (FFT)/inverse fast Fourier transform (IFFT), discrete Fourier transform (DFT)/inverse discrete Fourier transform (IDFT), 2D-FFT, 3D-FFT, matched filtering, an autocorrelation operation, wavelet transform, digital filtering, and the like, as well as threshold detection results, maximum/minimum value extraction results, and the like of results of the foregoing operations).
b) The second-level measurement quantity (a basic measurement quantity) includes a delay, Doppler, an angle, signal strength, and a multi-dimensional combination of delay, Doppler, angle and signal strength.
c) The third-level measurement quantity (a basic attribute/status) includes a distance, a speed, an angle/orientation, a radar cross section (RCS), and an acceleration.
d) The fourth-level measurement quantity (a progressive attribute/status) includes a space location, whether a target exists, a trajectory, an action, an expression, a vital sign, a quantity, an imaging result, weather, air quality, a shape, a material, and composition.

It should be noted that the sensing function node includes at least one of the following functions:
receiving a sensing service request, and determining a required sensing measurement quantity based on the sensing service request;
receiving a sensing measurement result (that is, a value of the sensing measurement quantity), where the sensing measurement quantity is the first-level measurement quantity and/or the second-level measurement quantity; generating a sensing result (the third-level measurement quantity); and responding to the sensing service request, where in this application, this function is referred to as a basic sensing function node;
receiving a sensing measurement result of the third-level measurement quantity, generating a sensing result (the fourth-level measurement quantity), and responding to the sensing service request, where in this application, this function is referred to as a derivative sensing function node;
receiving a sensing measurement result (that is, a value of the sensing measurement quantity), where the sensing measurement quantity is the first-level measurement quantity and/or the second-level measurement quantity and/or the third-level measurement quantity; generating a sensing result (the fourth-level measurement quantity); and responding to the sensing service request, where in this application, this function is referred to as an integrated sensing function node;
control over sensing quality of service (QOS), that is, controlling a sensing-related node for a sensing quality of service requirement, so as to meet the sensing service QoS requirement;
determining a sensing signal sending or receiving node or a sensing auxiliary node, where sensing signal sending or receiving nodes in a mobile communication system include a network device (for example, a base station) and user equipment UE (for example, a mobile phone), and the sensing auxiliary node is configured to provide sensing-assisted information such as sensing information of another sensor and geographic location information and the like used to improve wireless sensing performance;
determining a sensing link or a sensing manner, where the sensing link may include a Uu link (a base station performs sending/UE performs receiving or a base station performs receiving/UE performs sending), a sidelink (sending and receiving between UE), an echo link (a base station performs self-sending and self-receiving, or UE performs self-sending and self-receiving), and an inter-base station transceiver link (sending and receiving between base stations), and the sensing manner may include that a base station performs sending and UE performs receiving, UE performs sending and a base station performs receiving, a base station performs self-sending and self-receiving, sending and receiving between UE, sending and receiving between base stations, and UE performs self-sending and self-receiving;
determining a sensing signal, where potential sensing signals include a reference signal and a data signal, and the reference signal may be a communication reference signal or a sensing dedicated reference signal;
determining a time-frequency resource used for sensing, where potential sensing resources include a time-frequency resource (for example, a guard band) that is not used in communication, a time-frequency resource (for example, a reference signal or a data signal) that is used in communication, and a sensing dedicated time-frequency resource;
determining a configuration of the sensing signal needs to be further determined, and a potential configuration includes time, frequency, and space domain resource information of the sensing signal; if it is determined that a node that senses a time-frequency resource is not a sending node of the sensing signal, sending a sensing signal configuration to a sensing signal sending node;
determining a configuration of the sensing measurement quantity, where a potential configuration includes a sensing signal indication that needs to be measured, a quantity or time of sensing signals that need to be measured, a reporting indication of a measurement result, and the like; if it is determined that a node configured by using the sensing measurement quantity is not a receiving and measurement node of the sensing signal, sending a sensing measurement quantity configuration to a sensing signal receiving node;
determining and configuring a transmission channel for reporting a sensing measurement result, including establishing, modifying, or releasing the transmission channel;
determining an AMF, where after a network side determines the sensing function node based on a geographic range of the requested sensing service and a geographic range in which the sensing function node provides the sensing service, the sensing function node needs to determine the AMF in at least one of the following cases: (1) when a sensing target is specific UE in a case that the UE is a sensing signal sending node, a sensing signal receiving node, or a sensing auxiliary node, the sensing function node selects the AMF based on a geographic area that needs to be sensed and based on a tracking area identity (TAI) of the AMF requested from a network repository function (NRF) and/or an AMF ID/location and the like; (2) when sensing data needs to be transmitted by an AMF (for example, defined as a non-access stratum NAS message or an NAS layer as a transport bearer protocol layer for sensing data), the sensing function node selects the AMF based on geographic location information (such as a tracking area (TA)) of a sensing node that needs to transmit data and based on a TAI of the AMF requested from an NRF and/or an AMF ID/location; and (3) when the sensing target is 3GPP UE, the sensing function node determines the AMF based on a UE identity and the like.

In at least one embodiment of this application, the method further includes at least one of the following:
obtaining, by the first node, the sensing authorization information by using subscription information, which may be referred to as an option 1 for short;
sending, by the first node, query information to a target device, and receiving sensing authorization information sent by the target device, which may be referred to as an option 2 for short; or
receiving, by the first node, sensing authorization information sent by a target device, which may be referred to as an option 3 for short.

The target device includes at least one of the following:
a device having a sensing area authorization permission;
a device having a sensing target authorization permission; and
a sensing device.

The authorization solution in this embodiment of this application further includes: obtaining different sensing authorization information by using the foregoing plurality of options, or obtaining the sensing authorization information and/or updating the sensing authorization information in the foregoing plurality of manners. For example, option 1+option 2 are used, where the subscription information includes sensing allowed or sensing prohibited. If sensing is allowed, the network receives a sensing request related to the network and queries whether sensing is performed. For another example, option 1+option 3 are used. Based on the subscription information, the device updates the sensing authorization information in the manner 3.

In at least one embodiment of this application, the sensing request carries at least one of the following information:
a sensing type;
eleventh indication information indicating whether a sensing device is specified;
information specifying a sensing device, where if the sensing device is specified, the sensing request further includes list information of the specified sensing device, for example, a sensing device 1 is configured to send a sensing signal, a sensing device 2 is configured to receive and measure a sensing signal, and a sensing device 3 is configured to generate a sensing result;
a sensing area;
a sensing target;
an identifier of a sensing request sending node, which may also be referred to as an identifier of a sensing requester or an identifier of a sensing request initiator;
an identifier of a sensing result receiving node, which may also be referred to as an identifier of a sensing result user;
sensing content, which may also be understood as a sensing service type, and potential sensing content includes a distance, a speed, an orientation, a location, a trajectory, whether a target exists, environment reconstruction, respiration monitoring, heartbeat monitoring, motion identification, weather monitoring, air quality detection, and material composition analysis;
time information of execution of sensing, which may be absolute time information (Monday, 13:00-19:00) or relative time information (for example, within a next month), and the time information may include start time, end time, duration, or the like;
sensing quality of service QOS; and
an authentication credential, which may also be referred to as an authorization credential, such as a token.

Optionally, the sensing type is defined based on a sensing authorization or authentication requirement. A potential definition manner is as follows:
Type 1: To implement sensing, no sensing area authorization is required, and no sensing target authorization is required, and sensing content is common information. For example, for weather monitoring, this type has a low security privacy requirement. Generally, an authentication result is: to continue to perform sensing.
Type 2: A sensing area needs to be authenticated, and no sensing target authorization is required. In consideration of a dynamic change of a sensing area, area overlapping, or area inclusion/being included, the type 2 may be further classified into single authentication or dual authentication to better ensure sensing security privacy. Single authentication means that the network performs authentication once, and dual authentication means that the network performs authentication at least twice.
Type 3: A sensing target needs to be authenticated. The sensing area may need to be authorized or may not need to be authorized.

Optionally, specifying a meaning of the sensing device includes specifying a sensing device that performs at least one of sensing signal sending, sensing signal receiving, sensing signal measurement, sensing auxiliary data reporting, and sensing result generation. If one or more of the foregoing items is specified, it indicates that the sensing device is specified. If none of the foregoing items is specified, it indicates that no sensing device is specified.

As an optional embodiment, in a case that the sensing request carries the authentication credential, the method further includes:
obtaining, by the first node, an authentication manner for the authentication credential; and
performing, by the first node, authentication verification on the authentication credential in the sensing request in the obtained authentication manner, to determine whether to perform the sensing requested by the sensing request. If the authentication credential is valid, the sensing is performed. If the authentication credential is invalid, the sensing is rejected.

It should be noted that the authentication credential is generally time-sensitive. Therefore, in this embodiment of this application, it is recommended to perform authentication verification on the authentication credential each time.

Optionally, before the first node determines, based on the sensing authorization information, whether to perform sensing, the first node may further perform authentication on a sender of the sensing request and/or a receiver of the sensing result. This prevents an unauthorized sender of the sensing request from occupying a network resource, and prevents an unauthorized sensing result receiver from obtaining key information. As described above, when the sensing target, the sender of the sensing request, or the receiver of the sensing result is UE, it is easy for the network to perform authorization or authentication based on an association relationship between the sensing target/the sender of the sensing request/the receiver of the sensing result and the UE. When the sender of the sensing request/the receiver of the sensing result is not UE, the network needs to obtain an association relationship between communication information (for example, an IP address and a port number) of the sensing target/the sender of the sensing request/the receiver of the sensing result and identity information (an owner or a manager of an authorized sensing target/area), so that when the sensing request is received or the sensing result is sent, the sender or receiver of the sensing request may be authenticated to determine whether the sensing request matches the sensing authorization information; and then, sensing authentication is performed based on the sensing authorization information in a case that the sensing request matches the sensing authorization information.

To better describe the sensing authentication method provided in the embodiments of this application, several examples are used below for description.

### Example 1

A sensing authorization solution is that the sensing area owner/manager, the sensing target/sensing target owner/manager, or the sensing device provides the sensing authorization information for the sensing area, the sensing target, or the sensing device by using subscription information. The network may determine, based on the subscription information, whether to perform the requested sensing.

An AF (application function), an internal network function (for example, an AMF), or UE may send a sensing request, and a network function (for example, an NEF, an AMF, an SF, or an AUSF) performs authorization/authentication check on the sensing request. The sensing authorization information may be stored by the network function that performs the authorization/authentication, or may be stored by a network function (for example, a UDM) configured to store authorization information. If the sensing authorization information is stored by the network function configured to store the authorization information, the network function that performs authorization/authentication requests authorization/authentication information from the network function, and feeds back an authorization/authentication result. Based on the authorization/authentication result, the network determines whether to perform sensing. A process based on a 5G network is briefly described as follows:
Step 1: The AF sends sensing request information to the NEF, or the internal network function (for example, the SMF) sends a sensing request to the SF, or the UE sends a sensing request to the AMF. For details of content carried in the sensing request, reference may be made to the foregoing embodiment.
Step 2: If sensing authorization/authentication needs to be performed, the NEF, the SF, or the AMF corresponding to the receiver of the sensing request may perform sensing authorization/authentication, or the NEF/SF/AMF may request authorization/authentication from the AUSF. As described in this technical solution, in the example of the sensing type 1 (to implement sensing, no sensing area authorization/authentication is required, and no sensing target authorization/authentication is required, and sensing content is common information, for example, for weather monitoring, this type has a low security privacy requirement), sensing authorization/authentication may not need to be performed for the sensing area and the sensing target. When the NEF/SF/AMF/AUSF performs sensing authorization/authentication,
required sensing authorization information is obtained, and examples are as follows (including at least one of a sensing area, a sensing target, or a sensing device), where when the sensing device is specified in the sensing request, sensing device authorization information is required, or otherwise, authorization information of the sensing device is not required herein. Only when the sensing function SF determines a sensing device that performs each sensing function, authorization information of the sensing device is required:
a sensing area identifier, a sensing area name, or a sensing area coordinate range;
a sensing service network name of a sensing area, such as a public land mobile network (PLMN);
authorization information of the sensing area, where for content carried in the authorization information of the sensing area, reference may be made to the foregoing embodiment;
a sensing target identifier;
a sensing service network name of the sensing target, such as a PLMN;
authorization information of the sensing target, where for content carried in the authorization information of the sensing target, reference may be made to the foregoing embodiment;
a sensing device identifier;
a service network name of the sensing device, such as a PLMN; and authorization information of the sensing device, where for content carried in the
authorization information of the sensing device, reference may be made to the foregoing embodiment.

One method for obtaining the sensing authorization information is to request the required sensing authorization information from a UDM. For selection of the UDM, compared with selecting the UDM based on a UE-related identifier in communication, the UDM needs to be selected based on at least one of the sensing area, the sensing target, and the sensing device during sensing. For example, based on the sensing area identifier, the sensing area name, the sensing area coordinate range, or the like, authorization/authentication information of a sensing area, a sensing target, or a sensing device required for storing is selected according to the sensing target identifier, the sensing device identifier, or the like. Another method is that a required NEF/SF/AMF/AUSF locally stores authorization/authentication information of a required sensing area, sensing target, or sensing device. The information may be that the UDM pre-sends sensing authorization information to the NEF/SF/AMF/AUSF that performs authorization/authentication, or may be that the sensing authorization information is pre-sent to and stored in the NEF/SF/AMF/AUSF by using a sensing area owner/manager, a sensing target/sensing target owner/sensing target manager, and a sending device.

An authorization/authentication result is determined based on the sensing request and the corresponding sensing authorization information. For example, the sensing request is to perform vehicle speed sensing on a specific road area, and both a sensing requirement initiator and a sensing result user are the same, and are a traffic management department. In this case, if a manager, that is, the traffic management department, of the area in the subscription information, determines, based on the authorization information of the sensing area, that authorization/authentication succeeds, sensing may be performed. For example, the sensing request is to perform respiration monitoring sensing on a specific house area, where a sensing requirement initiator is a house owner, and a sensing result user is a child of the house owner. In this case, if an owner of the area, that is, the house owner, determines, based on the authorization information of the sensing area, that authorization/authentication succeeds, sensing may be performed. If the sensing result user is not within a sensing result user range authorized by sensing, authorization/authentication fails. If authorization/authentication fails, the NEF/SF/AMF rejects the sensing request and does not perform sensing.

The NEF/SF/AMF/AUSF sends an authentication result to the UDM.

Considering sensing efficiency and a sensing latency, the NEF/SF/AMF/AUSF/UDM stores an authentication status, including at least one of the sensing area identifier, the sensing target identifier, and the sensing device identifier, and further includes the authentication result, the timestamp, and the service network name. Optionally, the authentication status further includes one or more of an initiator of a sensing requirement, a user of a sensing result, sensing content, sensing time, and sensing QoS. For a same sensing request, repeated authentication is avoided without changing authorization information. In addition, the NEF/SF/AMF/AUSF may subscribe to the sensing authorization information, and once the sensing authorization information is updated, the UDM or another network function updates information.
Step 3: After the authorization/authentication succeeds, in a manner, the NEF selects an appropriate AMF, and sends a sensing service request message to the AMF. When the sensing service request is triggered by an internal network element, the internal network element selects an appropriate AMF and sends a sensing service request message to the AMF.

In the case of area-oriented sensing, the NEF selects, based on area information in an AF request, an AMF that serves the area.

In the case of target-oriented sensing, the NEF selects, based on target location information in an AF request, an AMF that serves the area. If the target has a UE communication module and has a UE capability, for example, a vehicle, it may be considered that the target-oriented sensing is to sense a circumference of the UE. In this case, an AMF that serves the UE may be selected as the AMF, and the NEF obtains, by querying the UDM, information about the AMF that serves the UE.

In another manner, the NEF may select an SF first, and then the SF selects an AMF. When the sensing service request is triggered by an internal network element, the internal network element selects an SF, and then the SF selects an AMF.

In the case of area-oriented sensing, the NEF selects, based on area information in an AF request, an SF that serves the area.

In the case of target-oriented sensing, the NEF selects, based on target location information in an AF request, an SF that serves the area. If the target has a UE communication module and has a UE capability, for example, a vehicle, it may be considered that the target-oriented sensing is to sense a circumference of the UE. In this case, an SF that serves the UE may be selected as the SF, and the NEF obtains, by querying the UDM, an ID of an AMF that serves the UE, and then, selects an appropriate SF based on the ID of the AMF.
Step 4: The AMF sends the sensing request to the SF.
Step 5: If the SF determines a sensing manner and a sensing base station/UE based on the sensing request, sensing manners include: a base station performs self-sending and self-receiving, sending and receiving between base stations, UE performs sending and a base station performs receiving, a base station performs sending and UE performs receiving, UE performs self-sending and self-receiving, and sending and receiving between UEs based on division from the perspective of the sensing signal sending node and receiving node.

If the base station and the terminal can perform a sensing operation, a sensing response is returned to the SF, where the sensing response carries a success indication, or otherwise, carries a failure indication. A sensing network element then returns a sensing response to a third-party application that requests the service.
Step 6: The SF performs sensing calculation based on sensing measurement data fed back by the base station, and obtains a final sensing result.
Step 7: The SF returns the sensing result to the AMF. For an area sensing scenario, the SF may return the sensing result to the AF through the AMF and the NEF, or directly return the sensing result to the AF through the NEF.
Step 8: The AMF returns the sensing result to the AF through the NEF. When the authorization/authentication is triggered by an internal network element, the AMF sends the sensing result to the internal network element.

### Example 2

A sensing authorization and authentication solution is that when a sensing request is received, a network queries, based on the sensing request (at least one of a sensing area, a sensing target, or a specified sensing device), whether a corresponding device that has an authorization permission for the area, a device that has an authorization permission for the target, or a sensing device allows to perform sensing.

An AF (application function), an internal network function (for example, an AMF), or UE may send a sensing request, and a network function (for example, an NEF, an AMF, an SF, or an AUSF) performs authorization/authentication check on the sensing request. The network function determines, based on the sensing request, a device that has an authorization permission for the involved sensing area and/or sensing target. The network function performs sensing authorization/authentication by querying a device that has an authorization permission. If the sensing device is specified in the sensing request, the network function needs to query the specified sensing device for sensing authorization/authentication. A process based on a 5G network is briefly described as follows:

A process of sending and receiving a sensing request and performing sensing after the authorization/authentication succeeds is the same as that in Example 1, and details are not described in this example.
Step 1: If sensing authorization/authentication needs to be performed, an NEF, an SF, or an AMF corresponding to a receiver of the sensing request may perform sensing authorization/authentication, or the NEF/SF/AMF may request authorization/authentication from an AUSF. As described in this technical solution, in the example of the sensing type 1 (to implement sensing, no sensing area authorization/authentication is required, and no sensing target authorization/authentication is required, and sensing content is common information, for example, for weather monitoring, this type has a low security privacy requirement), sensing authorization/authentication may not need to be performed for the sensing area and the sensing target. When the NEF/SF/AMF/AUSF performs sensing authorization/authentication,
a device that has an authorization permission for the involved sensing area and/or sensing target is determined based on the sensing request and subscription information.

The NEF/SF/AMF/AUSF sends a sensing authorization/authentication request to at least one of a device that has a sensing area authorization permission, a device that has a sensing target authorization permission, or a sensing device. The sensing authorization/authentication request information is the same as the sensing request information in the present technical proposal.

The device that has the sensing area authorization permission, the device that has the sensing target authorization permission, or the sensing device correspondingly determines an authorization/authentication result of a sensing area, a sensing target, or the sensing device, and sends a sensing authorization/authentication response. The sensing authorization/authentication response includes at least an indication of whether authorization/authentication succeeds, and optionally may further include: a timestamp of the authentication result, to prevent abuse such as playback of the authorization/authentication result; and valid duration of the authentication result, to prevent same sensing authorization/authentication from being repeatedly requested. It should be noted that the device that has the sensing area authorization permission, the device that has the sensing target authorization permission, or the sensing device may be three different devices, any two of which are a same device, or three of which are a same device.

The NEF/SF/AMF/AUSF determines, based on the received sensing authorization/authentication response, whether authorization/authentication succeeds. If the authorization/authentication succeeds, sensing may be performed. If the authorization/authentication fails, the NEF/SF/AMF/AUSF rejects the sensing request, and does not perform sensing.

Considering sensing efficiency and a sensing latency, the NEF/SF/AMF/AUSF/UDM stores an authentication status, including at least one of the sensing area identifier, the sensing target identifier, and the sensing device identifier, and further includes the authentication result, the timestamp, and the service network name. Optionally, the authentication status further includes one or more of an initiator of a sensing requirement, a user of a sensing result, sensing content, sensing time, and sensing QoS. For a same sensing request, repeated authentication is avoided without changing authorization information.

### Example 3

A sensing authorization and authentication solution is that an initiator (sensing requester) of a sensing requirement obtains a sensing authorization credential from a required sensing area, sensing target, or sensing device. When a sensing request is sent, the obtained sensing authorization credential needs to be carried. A network function that is responsible for performing sensing and authorization/authentication obtains a method for authenticating an authentication credential, or a network function that is responsible for performing sensing and authorization/authentication agrees on an authentication method of the authentication credential with an authorization party of the sensing area/sensing target/sensing device through an offline means or message interaction. Therefore, when a network receives a sensing request with the authentication credential, the network determines, based on a known authentication method authentication, whether to allow to perform sensing. In the credential-based sensing authorization and authentication method, in one aspect, the network may not need to exchange sensing authorization information with the sensing area/target/device, and in another aspect, sensing authorization is authorized directly by the sensing area/target/device without a network proxy, so that the sensing area/target/device has a full authorization range, which facilitates updating authorization information at any time. In addition, there may be a plurality of solutions for the credential, for example, a hash algorithm (generally, this relationship is met: f(data)=key, where after data of any length is input, a fixed-length data key is output after processing by the hash algorithm, and at the same time, this process is irreversible, and the data cannot be derived from the key; in this solution, the function f( ) is an authentication method, and the credential may be data and the key), a token, or the like, which has better extensibility.

A process of sending and receiving a sensing request and performing sensing after the authorization/authentication succeeds is the same as that in Example 1, and details are not described in this example. When the sensing credential is a token, a sensing authorization/authentication solution based on the token is briefly described as follows.
Step 1: An initiator (sensing requester) of a sensing requirement obtains an authorization token of a required sensing area, sensing target, or sensing device. One obtaining manner is that the authorization token is obtained through offline negotiation with an owner/manager of the sensing area and/or the sensing target. Another obtaining manner is: sending a sensing authorization request to a device that has a sensing area authorization permission, a device that has a sensing target authorization permission, or a sensing device to request a token.
Step 2: A network function that is responsible for sensing authentication obtains an authentication manner of a responsible sensing area, sensing target, or sensing device (that is, a method of decoding the token and determining whether the token is valid). One obtaining manner is that the authorization token is obtained through offline negotiation with an owner/manager of the sensing area and/or the sensing target. Another obtaining manner is: sending a sensing authentication request to a device that has a sensing area authentication permission, a device that has a sensing target authentication permission, or a sensing device to request an authentication manner.

There is no absolute sequence relationship between step 1 and step 2. Step 1 may be performed before step 2, step 2 may be performed before step 1, or step 1 and step 2 may be performed simultaneously.
Step 3: When sending the sensing request, the initiator of the sensing request carries obtained token information.
Step 4: A network verifies the token information in the sensing request in an obtained authentication manner, and if the token is valid, performs sensing. If the token is invalid, the sensing is rejected.

The token is generally time-sensitive. Therefore, in this solution, it is recommended to perform authentication verification on the token each time.

### Example 4

The sensing area authorization information, the sensing target authorization information, and the sensing device authorization information may change due to a willingness of a person who performs authorization or another reason. When the sensing area authorization information, the sensing target authorization information, and the sensing device authorization information change, a potential updating manner includes: changing a signed contract or an authorization agreement in an offline manner, and updating authorization/authentication information based on message interaction. This embodiment provides a method for updating sensing authorization information, focusing on updating authorization information based on message interaction.

When the sensing area, the sensing target, or the sensing device needs to change the sensing authorization information due to reasons such as a willingness of the person who performs authorization, a battery level, or some emergencies, a manager/owner of the sensing area, the sensing target, or the sensing device may update the sensing authorization information by using an on/off/setting option of a device that has a sensing area authorization permission, a device that has a sensing target authorization permission, or an operating system interface of the sensing device, or a device that has a sensing area authorization permission, a device that has a sensing target authorization permission, or a physical on/off key of the sensing device, or by sending a short message, or by using a specified application function (the application function may be deployed on the device that has the sensing area authorization permission, the device that has the sensing target authorization permission, or the sensing device, or the application function is deployed on another location) message, or the like. Correspondingly, an interaction procedure of updating the sensing authorization information is described as follows.
Step 1: At least one of a device that has a sensing area authorization permission, a device that has a sensing target authorization permission, a sensing device, or an application function sends at least one of sensing area authorization information, sensing target authorization information, or sensing device authorization information, where the authorization information is used to update corresponding sensing authorization information and/or sensing authentication information. For the sensing authorization information, refer to the technical solution, and the sensing authentication information mainly includes whether to allow execution of sensing.
Step 2: After receiving the sensing authorization/authentication update information, a network function node (for example, a UDM/NEF/SF/AMF/AUSF) that is responsible for maintaining the sensing authorization and/or authentication information sends a message to notify, based on a sensing authorization/authentication subscription, a corresponding subscription node of update of the sensing authorization/authentication information.
Step 3: A network function node (for example, an NEF/SF/AMF/AUSF) that subscribes to node sensing authorization and/or authentication of the sensing authorization/authentication information obtains updated authorization/authentication information, and performs sensing authorization/authentication based on the updated authorization/authentication information. If a sensing authorization/authentication result is different from a result of previous authorization/authentication, an updated sensing authorization/authentication result is sent to a sensing requester.

If authorization/authentication update of the sensing area, the sensing target, or the sensing device is a credential-based manner, it indicates whether authorization/authentication is applied to subsequent sensing or current sensing and subsequent sensing. If authorization/authentication is applied to subsequent sensing, a network function that is responsible for performing sensing authorization/authentication authenticates a newly received sensing request by using update information. If update is applied to current sensing, the network function needs to perform authentication on the ongoing sensing. If an authentication result is that the requested sensing is not performed, a sensing requester needs to be notified of a new sensing authentication result. Alternatively, if an authentication result is the requested sensing is not performed, a sensing requester is notified to update the sensing authorization/authentication information (for example, a token). The sensing authentication is performed based on updated credential information, and a sensing requester is notified of the updated the sensing authorization/authentication result. The notification can also indicate that an updated sensing authorization/authentication information is no longer being received.

In conclusion, in this embodiment of this application, the first node obtains the sensing request and at least one of the sensing area authorization information, the sensing target authorization information, and the sensing device authorization information corresponding to the sensing request, to perform sensing authentication, so as to determine, based on the authentication result, whether to perform the sensing requested by the sensing request. Therefore, authorization and authentication of the sensing area, the sensing target, or the sensing device involved in the sensing are addressed. This embodiment can ensure security and privacy of sensing, prevent unauthorized sensing of a specific area or a specific target, and prevent unauthorized designation of a sensing device from causing the sensing device to be tracked or captured.

The sensing authentication method provided in the embodiments of this application may be performed by a sensing authentication apparatus. In the embodiments of this application, the sensing authentication apparatus provided in the embodiments of this application is described by using an example in which the sensing authentication apparatus performs the sensing authentication method.

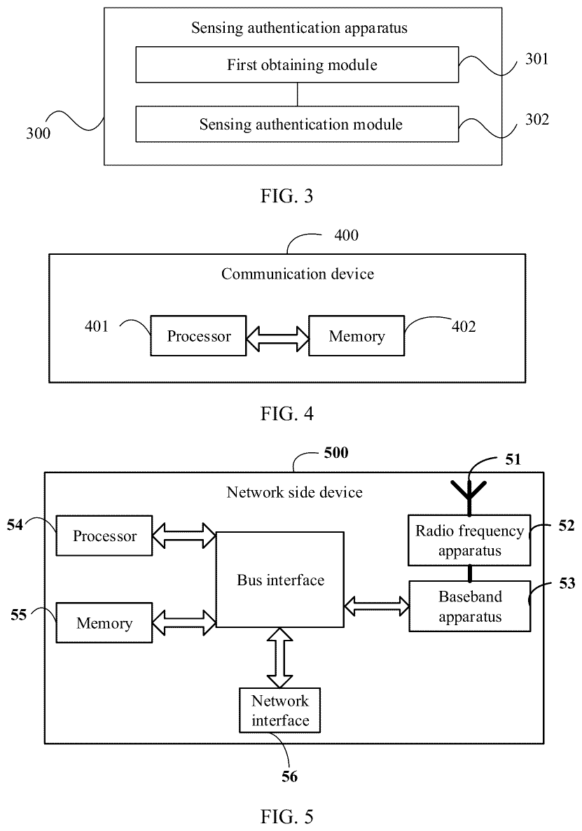

As shown in FIG. 3, an embodiment of this application further provides a sensing authentication apparatus 300, including:
a first obtaining module 301, configured to obtain a sensing request and sensing authorization information corresponding to the sensing request; and
a sensing authentication module 302, configured to perform sensing authentication based on the sensing authorization information, where an authentication result of the sensing authentication is used to indicate whether to perform sensing requested by the sensing request.

The sensing authorization information includes at least one of sensing area authorization information, sensing target authorization information, and sensing device authorization information.

As an optional embodiment, the sensing area authorization information includes at least one of the following:
first indication information indicating that sensing is allowed in a first area;
a range that is of the first area and that is allowed to be sensed;
second indication information indicating that sensing is prohibited in the first area;
a range that is of the first area and that is prohibited from being sensed; and
communication information of a device that has an authorization permission for the first area.

As an optional embodiment, the range that is of the first area and that is allowed to be sensed includes at least one of the following:
content that is of the first area and that is allowed to be sensed;
sensing measurement data that is of the first area and that is allowed to be sensed;
a sensing request sending node allowed by the first area;
a sensing result receiving node allowed by the first area;
a sensing device allowed by the first area, where the sensing device is a device that performs at least one of sensing signal sending, sensing signal receiving, sensing signal measurement, sensing auxiliary data reporting, and sensing result generation;
time during which the first area is allowed to be sensed; and
sensing quality of service QoS allowed by the first area.

As an optional embodiment, the range that is of the first area and that is prohibited from being sensed includes at least one of the following:
content that is of the first area and that is prohibited from being sensed;
sensing measurement data that is of the first area and that is prohibited from being sensed;
a sensing request sending node prohibited by the first area;
a sensing result receiving node prohibited by the first area;
a sensing device prohibited by the first area, where the sensing device is a device that performs at least one of sensing signal sending, sensing signal receiving, sensing signal measurement, sensing auxiliary data reporting, and sensing result generation;
time during which the first area is prohibited from being sensed; and
sensing quality of service QoS prohibited by the first area.

As an optional embodiment, the sensing target authorization information includes at least one of the following:
third indication information indicating that a first target is allowed to be sensed;
a range that is of the first target and that is allowed to be sensed;
fourth indication information indicating that the first target is prohibited from being sensed;
a range that is of the first target and that is prohibited from being sensed; and
communication information of a device that has an authorization permission for the first target.

As an optional embodiment, the range that is of the first target and that is allowed to be sensed includes at least one of the following:
content that is of the first target and that is allowed to be sensed;
sensing measurement data that is of the first target and that is allowed to be sensed;
a sensing request sending node allowed by the first target;
a sensing result receiving node allowed by the first target;
a sensing device allowed by the first target, where the sensing device is a device that performs at least one of sensing signal sending, sensing signal receiving, sensing signal measurement, sensing auxiliary data reporting, and sensing result generation;
time during which the first target is allowed to be sensed;
an area in which the first target is allowed to be sensed; and
sensing quality of service QoS allowed by the first target.

As an optional embodiment, the range that is of the first target and that is prohibited from being sensed includes at least one of the following:
content that is of the first target and that is prohibited from being sensed;
sensing measurement data that is of the first target and that is prohibited from being sensed;
a sensing request sending node prohibited by the first target;
a sensing result receiving node prohibited by the first target;
a sensing device prohibited by the first target, where the sensing device is a device that performs at least one of sensing signal sending, sensing signal receiving, sensing signal measurement, sensing auxiliary data reporting, and sensing result generation;
time during which the first target is prohibited from being sensed;
an area in which the first target is prohibited from being sensed; and
sensing quality of service QoS prohibited by the first target.

As an optional embodiment, the sensing device authorization information includes at least one of the following:
fifth indication information indicating that a first device is allowed to participate in sensing;
a range in which the first device is allowed to participate in sensing;
sixth indication information indicating that the first device is prohibited from participating in sensing; and
a range in which the first device is prohibited from participating in sensing.

As an optional embodiment, the range that is of the first device and that is allowed to participate in sensing includes at least one of the following:
a sensing function that the first device is allowed to participate in, where the sensing function includes at least one of sensing signal sending, sensing signal receiving, sensing signal measurement, sensing auxiliary data reporting, and sensing result generation;
seventh indication information indicating that the first device is allowed to be determined by a sensing request sending node to participate in sensing;
eighth indication information indicating a sensing request sending node that is allowed to determine that the first device participates in sensing;
a sensing measurement quantity allowed by the first device; and
sensing auxiliary data allowed by the first device, where the sensing auxiliary data includes at least one of location information, time information, speed information, and target identification information.

As an optional embodiment, the range that is of the first device and that is prohibited from participating in sensing includes at least one of the following:
ninth indication information indicating that the first device is prohibited from being determined by a sensing request sending node to participate in sensing;
tenth indication information indicating a sensing request sending node that is prohibited from determining that the first device participates in sensing;
a sensing measurement quantity prohibited by the first device; and
sensing auxiliary data prohibited by the first device, where the sensing auxiliary data includes at least one of location information, time information, speed information, and target identification information.

As an optional embodiment, the apparatus further includes at least one of the following modules:
a second obtaining module, configured to obtain the sensing authorization information by using subscription information;
a third obtaining module, configured to: send query information to a target device, and receive sensing authorization information sent by the target device; and
a fourth obtaining module, configured to receive sensing authorization information sent by a target device.

As an optional embodiment, the target device includes at least one of the following:
a device having a sensing area authorization permission;
a device having a sensing target authorization permission; and
a sensing device.

As an optional embodiment, the sensing request carries at least one of the following information:
a sensing type;
eleventh indication information indicating whether a sensing device is specified;
information specifying a sensing device;
a sensing area;
a sensing target;
an identifier of a sensing request sending node;
an identifier of a sensing result receiving node;
sensing content;
time information of execution of sensing;
sensing quality of service QoS; and
an authentication credential.

As an optional embodiment, in a case that the sensing request carries the authentication credential, the apparatus further includes:
a fifth obtaining module, configured to obtain an authentication manner for the authentication credential; and
an authentication module, configured to perform authentication verification on the authentication credential in the sensing request in the obtained authentication manner, to determine whether to perform the sensing requested by the sensing request.

In this embodiment of this application, the first node obtains the sensing request and at least one of the sensing area authorization information, the sensing target authorization information, and the sensing device authorization information corresponding to the sensing request, to perform sensing authentication, so as to determine, based on the authentication result, whether to perform the sensing requested by the sensing request. Therefore, authorization and authentication of the sensing area, the sensing target, or the sensing device involved in the sensing are addressed. This embodiment can ensure security and privacy of sensing, prevent unauthorized sensing of a specific area or a specific target, and prevent unauthorized designation of a sensing device from causing the sensing device to be tracked or captured.

It should be noted that the sensing authentication apparatus provided in the embodiments of this application is an apparatus that can perform the foregoing sensing authentication method. Therefore, all embodiments of the foregoing sensing authentication method are applicable to the apparatus, and a same or similar beneficial effect can be achieved. Details are not repeatedly described herein.

The sensing authentication apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The sensing authentication apparatus provided in this embodiment of this application can implement the processes in the method embodiments in FIG. 1 and FIG. 2, and a same technical effect is achieved. To avoid repetition, details are not described herein again.

Optionally, as shown in FIG. 4, an embodiment of this application further provides a communication device 400, including a processor 401 and a memory 402, and the memory 402 stores a program or instructions that can be run on the processor 401. For example, in a case that the communication device 400 is a first node, the program or the instructions are executed by the processor 401 to implement the steps of the foregoing embodiments of the sensing authentication method, and a same technical effect can be achieved. To avoid repetition, details are not described herein again.

An embodiment of this application further provides a network side device, including a processor and a communication interface. The communication interface is configured to obtain a sensing request and sensing authorization information corresponding to the sensing request. The processor is configured to perform sensing authentication based on the sensing authorization information to determine whether to perform sensing requested by the sensing request. The sensing authorization information includes at least one of sensing area authorization information, sensing target authorization information, and sensing device authorization information. This embodiment of the network side device corresponds to the foregoing method embodiment on the first node side. Each implementation process and implementation manner of the foregoing method embodiment may be applicable to this embodiment of the network side device, and a same technical effect can be achieved.

Specifically, an embodiment of this application further provides a network side device. As shown in FIG. 5, the network side device 500 includes an antenna 51, a radio frequency apparatus 52, a baseband apparatus 53, a processor 54, and a memory 55. The antenna 51 is connected to the radio frequency apparatus 52. In an uplink direction, the radio frequency apparatus 52 receives information through the antenna 51, and sends the received information to the baseband apparatus 53 for processing. In a downlink direction, the baseband apparatus 53 processes information that needs to be sent, and sends processed information to the radio frequency apparatus 52. The radio frequency apparatus 52 processes the received information, and sends processed information through the antenna 51.

In the foregoing embodiment, the method performed by the network side device may be implemented in the baseband apparatus 53. The baseband apparatus 53 includes a baseband processor.

For example, the baseband apparatus 53 may include at least one baseband board. A plurality of chips are disposed on the baseband board. As shown in FIG. 5, one chip is, for example, a baseband processor, and is connected to the memory 55 by using a bus interface, to invoke a program in the memory 55 to perform the operations of the network device shown in the foregoing method embodiment.

The network side device may further include a network interface 56, and the interface is, for example, a common public radio interface (CPRI).

Specifically, the network side device 500 in this embodiment of this application further includes an instruction or a program that is stored in the memory 55 and that can run on the processor 54. The processor 54 invokes the instruction or the program in the memory 55 to perform the method performed by the modules shown in FIG. 3, and a same technical effect is achieved. To avoid repetition, details are not described herein again.

An embodiment of this application further provides a readable storage medium. The readable storage medium stores a program or an instruction, and when the program or the instruction is executed by a processor, the processes of the foregoing embodiment of the sensing authentication method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip, the chip includes a processor and a communication interface, the communication interface is coupled to the processor, and the processor is configured to run a program or an instruction to implement the processes of the foregoing embodiment of the sensing authentication method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a non-volatile storage medium, and the computer program/program product is executed by at least one processor to implement the processes of the foregoing embodiment of the sensing authentication method, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a desireable implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A sensing authentication method, comprising:
obtaining, by a first node, a sensing request and sensing authorization information corresponding to the sensing request; and
performing, by the first node, sensing authentication based on the sensing authorization information, wherein an authentication result of the sensing authentication is used to indicate whether to perform sensing requested by the sensing request; wherein
the sensing authorization information comprises at least one of sensing area authorization information, sensing target authorization information, or sensing device authorization information.

2. The method according to claim 1, wherein the sensing area authorization information comprises at least one of the following:
first indication information indicating that sensing is allowed in a first area;
a range that is of the first area and that is allowed to be sensed;
second indication information indicating that sensing is prohibited in the first area;
a range that is of the first area and that is prohibited from being sensed; or
communication information of a device that has an authorization permission for the first area.

3. The method according to claim 2, wherein the range that is of the first area and that is allowed to be sensed comprises at least one of the following:
content that is of the first area and that is allowed to be sensed;
sensing measurement data that is of the first area and that is allowed to be sensed;
a sensing request sending node allowed by the first area;
a sensing result receiving node allowed by the first area;
a sensing device allowed by the first area, wherein the sensing device is a device that performs at least one of sensing signal sending, sensing signal receiving, sensing signal measurement, sensing auxiliary data reporting, or sensing result generation;
time during which the first area is allowed to be sensed; or
sensing quality of service QOS allowed by the first area.

4. The method according to claim 2, wherein the range that is of the first area and that is prohibited from being sensed comprises at least one of the following:
content that is of the first area and that is prohibited from being sensed;
sensing measurement data that is of the first area and that is prohibited from being sensed;
a sensing request sending node prohibited by the first area;
a sensing result receiving node prohibited by the first area;
a sensing device prohibited by the first area, wherein the sensing device is a device that performs at least one of sensing signal sending, sensing signal receiving, sensing signal measurement, sensing auxiliary data reporting, or sensing result generation;
time during which the first area is prohibited from being sensed; or
sensing quality of service QoS prohibited by the first area.

5. The method according to claim 1, wherein the sensing target authorization information comprises at least one of the following:
third indication information indicating that a first target is allowed to be sensed;
a range that is of the first target and that is allowed to be sensed;
fourth indication information indicating that the first target is prohibited from being sensed;
a range that is of the first target and that is prohibited from being sensed; or
communication information of a device that has an authorization permission for the first target.

6. The method according to claim 5, wherein the range that is of the first target and that is allowed to be sensed comprises at least one of the following:
content that is of the first target and that is allowed to be sensed;
sensing measurement data that is of the first target and that is allowed to be sensed;
a sensing request sending node allowed by the first target;
a sensing result receiving node allowed by the first target;
a sensing device allowed by the first target, wherein the sensing device is a device that performs at least one of sensing signal sending, sensing signal receiving, sensing signal measurement, sensing auxiliary data reporting, or sensing result generation;
time during which the first target is allowed to be sensed;
an area in which the first target is allowed to be sensed; or
sensing quality of service QoS allowed by the first target.

7. The method according to claim 5, wherein the range that is of the first target and that is prohibited from being sensed comprises at least one of the following:
content that is of the first target and that is prohibited from being sensed;
sensing measurement data that is of the first target and that is prohibited from being sensed;
a sensing request sending node prohibited by the first target;
a sensing result receiving node prohibited by the first target;
a sensing device prohibited by the first target, wherein the sensing device is a device that performs at least one of sensing signal sending, sensing signal receiving, sensing signal measurement, sensing auxiliary data reporting, or sensing result generation;
time during which the first target is prohibited from being sensed;
an area in which the first target is prohibited from being sensed; or
sensing quality of service QoS prohibited by the first target.

8. The method according to claim 1, wherein the sensing device authorization information comprises at least one of the following:
fifth indication information indicating that a first device is allowed to participate in sensing;
a range in which the first device is allowed to participate in sensing;
sixth indication information indicating that the first device is prohibited from participating in sensing; or
a range in which the first device is prohibited from participating in sensing.

9. The method according to claim 8, wherein the range in which the first device is allowed to participate in sensing comprises at least one of the following:
a sensing function that the first device is allowed to participate in, wherein the sensing function comprises at least one of sensing signal sending, sensing signal receiving, sensing signal measurement, sensing auxiliary data reporting, or sensing result generation;
seventh indication information indicating that the first device is allowed to be determined by a sensing request sending node to participate in sensing;
eighth indication information indicating a sensing request sending node that is allowed to determine that the first device participates in sensing;
a sensing measurement quantity allowed by the first device; or
sensing auxiliary data allowed by the first device, wherein the sensing auxiliary data comprises at least one of location information, time information, speed information, or target identification information.

10. The method according to claim 8, wherein the range in which the first device is prohibited from participating in sensing comprises at least one of the following:
ninth indication information indicating that the first device is prohibited from being determined by a sensing request sending node to participate in sensing;
tenth indication information indicating a sensing request sending node that is prohibited from determining that the first device participates in sensing;
a sensing measurement quantity prohibited by the first device; or
sensing auxiliary data prohibited by the first device, wherein the sensing auxiliary data comprises at least one of location information, time information, speed information, or target identification information.

11. The method according to claim 1, wherein the method further comprises at least one of the following:
obtaining, by the first node, the sensing authorization information by using subscription information;
sending, by the first node, query information to a target device, and receiving sensing authorization information sent by the target device; or
receiving, by the first node, sensing authorization information sent by a target device.

12. The method according to claim 11, wherein the target device comprises at least one of the following:
a device having a sensing area authorization permission;
a device having a sensing target authorization permission; or
a sensing device.

13. The method according to claim 1, wherein the sensing request carries at least one of the following:
a sensing type;
eleventh indication information indicating whether a sensing device is specified;
information specifying a sensing device;
a sensing area;
a sensing target;
an identifier of a sensing request sending node;
an identifier of a sensing result receiving node;
sensing content;
time information of execution of sensing;
sensing quality of service QoS; or
an authentication credential.

14. The method according to claim 13, wherein in a case that the sensing request carries the authentication credential, the method further comprises:
obtaining, by the first node, an authentication manner for the authentication credential; and
performing, by the first node, authentication verification on the authentication credential in the sensing request in the obtained authentication manner, to determine whether to perform the sensing requested by the sensing request.

15. A first node, comprising a processor and a memory, wherein the memory stores a program or instructions that are capable of being run on the processor, and the processor, upon executing the program or the instructions, is configured to:
obtain a sensing request and sensing authorization information corresponding to the sensing request; and
perform sensing authentication based on the sensing authorization information, wherein an authentication result of the sensing authentication is used to indicate whether to perform sensing requested by the sensing request; wherein
the sensing authorization information comprises at least one of sensing area authorization information, sensing target authorization information, or sensing device authorization information.

16. The first node according to claim 15, wherein the sensing area authorization information comprises at least one of the following:
first indication information indicating that sensing is allowed in a first area;
a range that is of the first area and that is allowed to be sensed;
second indication information indicating that sensing is prohibited in the first area;
a range that is of the first area and that is prohibited from being sensed; or
communication information of a device that has an authorization permission for the first area.

17. The first node according to claim 15, wherein the sensing target authorization information comprises at least one of the following:
third indication information indicating that a first target is allowed to be sensed;
a range that is of the first target and that is allowed to be sensed;
fourth indication information indicating that the first target is prohibited from being sensed;
a range that is of the first target and that is prohibited from being sensed; or
communication information of a device that has an authorization permission for the first target.

18. The first node according to claim 15, wherein the sensing device authorization information comprises at least one of the following:
fifth indication information indicating that a first device is allowed to participate in sensing;
a range in which the first device is allowed to participate in sensing;
sixth indication information indicating that the first device is prohibited from participating in sensing; or
a range in which the first device is prohibited from participating in sensing.

19. The first node according to claim 15, wherein the processor is further configured to:
obtain the sensing authorization information by using subscription information;
send query information to a target device, and receive sensing authorization information sent by the target device; or
receive sensing authorization information sent by a target device.

20. A non-transitory computer-readable storage medium storing a program or instructions thereon, wherein the program or the instructions, upon being executed by a processor of a first node, is used for implementing operations comprising:
obtaining a sensing request and sensing authorization information corresponding to the sensing request; and
performing sensing authentication based on the sensing authorization information, wherein an authentication result of the sensing authentication is used to indicate whether to perform sensing requested by the sensing request; wherein
the sensing authorization information comprises at least one of sensing area authorization information, sensing target authorization information, or sensing device authorization information.
